(19) United States
(12) Patent Application Publication
(10) Pub. No.: US 2017/0353434 A1
(43) Pub. Date: Dec. 7, 2017

(54) METHODS FOR DETECTION OF REFLECTED CROSS SITE SCRIPTING ATTACKS

(71) Applicant: QUALCOMM Incorporated, San Diego, CA (US)

(72) Inventors: Nabeel Ahmad Al-Saber, San Diego, CA (US); Subrato Kumar De, San Diego, CA (US); Dineel Diwakar Sule, San Diego, CA (US)

(21) Appl. No.: 15/401,998

(22) Filed: Jan. 9, 2017

Related U.S. Application Data
(60) Provisional application No. 62/346,925, filed on Jun. 7, 2016.

(51) Int. Cl. H04L 29/06; H04L 29/08

(52) U.S. Cl. CPC H04L 63/0254; H04L 69/16; H04L 67/20; H04L 63/1425; H04L 67/02; H04L 63/1466; H04L 67/10

(57) ABSTRACT

An anti-cross-site scripting (anti-XSS) feature is provided at an operating system without reliance on higher-level third-party software (e.g., browsers, anti-virus software, etc.). A Uniform Resource Locator (URL) link is intercepted at a kernel level of an operating system of a device. It is then ascertained whether the URL link includes a cross-site script. If so, a determination is also made as to whether the cross-site script is an untrusted script (e.g., potentially harmful, malicious, or non-benign script). Execution of the URL link is terminated if it is determined that the cross-site script is an untrusted script.

### CROSS-REFERENCE TO RELATED APPLICATIONS

The present application for patent claims priority to U.S. Provisional Application No. 62/346,925, filed Jun. 7, 2016 and entitled “Improved Methods For Detection of Reflected Cross Site Scripting (XSS) Attacks”, which application is assigned to the assignee hereof and hereby expressly incorporated by reference herein.

### TECHNICAL FIELD

The novel aspects disclosed herein generally relate to internet security, and more specifically, though not exclusively, to methods for detecting and inhibiting cross-site scripting attacks at the operating system and/or kernel level.

### BACKGROUND

Cross-site scripting (XSS) is a type of computer security vulnerability typically found in web applications. XSS enables attackers to inject client-side scripts into web pages viewed by other users (e.g., victims). A cross-site scripting vulnerability may be used by attackers to bypass security access controls such as a same-origin policy.

FIG. 1 illustrates an example of a reflected XSS attack. An attacker 100 may inject malicious, harmful, untrusted, tainted, and/or non-benign script (e.g., JavaScript) through a Uniform Resource Locator (URL) of a trusted webpages by, for example, adding a link with a modified URL 104 which includes the malicious, harmful, untrusted, tainted, and/or non-benign script. For instance, such modified URL may include a domain portion (e.g., www.target_website.com) and a script portion, which incorporates code or instructions to perform malicious, harmful, untrusted, and/or non-benign operations (e.g., operations to access, obtain, and/or extract data or information from a victim or victim's device, or victim's account without knowledge, notification to, or approval from the victim). Because any legitimate website domain may be used for such malicious, harmful, untrusted, tainted, and/or non-benign injection, URL blacklisting is ineffective to protect against XSS attacks.

When a victim/device 106 clicks the URL link 107, the injected malicious, harmful, untrusted, tainted, and/or non-benign script can access the victim's cookies, passwords, or other sensitive information on that website, and/or redirect the user to a malicious site. For instance, the malicious script 104 may be submitted with the script into a webserver 108 as part of a query string 110. The malicious script is reflected 112 (i.e., sent back) to the victim's browser (on the user device 106) as part of the web page. The malicious script can then perform its malicious purpose, e.g., read a victim's private data, and sends it back 112 to the attacker 100.

Since the malicious script or code runs in the victim's session, it works within the definition of the same-origin policy and it is not distinguishable from normal application behavior. Consequently, there is no visible platform/device level activity that can identify XSS web security exploits. These web browser integrated anti-XSS capabilities operate at higher levels of a system, like an application level, an HTTP stack implemented by the browser, and URL string matching.

A solution is needed that provides anti-XSS capabilities at an operating-system level (i.e., built into the operating system OS) so that reliance on web browser security or other third-party software is not necessary.

### SUMMARY

A first aspect provides a method for detecting and/or inhibiting cross-site scripting attacks. A Uniform Resource Locator (URL) link may be intercepted at a kernel level of an operating system of a device. It is then ascertained whether the URL link includes a cross-site script. If so, it is determined whether the cross-site script is an untrusted script (e.g., malicious, harmful, non-benign script). Execution of the URL link may be terminated if it is determined that the cross-site script is an untrusted script.

In one example, determining whether the cross-site script is an untrusted script, includes comparing a plurality of features of the URL link to a database of pre-identified features in malicious/untrusted URLs and/or benign/safe URLs.

In various examples, the URL link may be intercepted: (a) at a TCP socket stream, (b) at a transport layer or a network layer of a protocol stack, or (c) by detecting an Android operating system intent call.

In one example, the untrusted script within the URL link is intended to perform unauthorized operations on an operating system or application executed on the device. For instance, the untrusted script may be a reflected cross site script.

In some implementations, execution of the URL link is terminated by: (a) informing a user of the potential security risk posed by the URL link; and (b) terminating the untrusted script only upon receiving user instructions to do so. In other examples, execution of the URL link is terminated by filtering out packets for the URL link from a TCP socket stream, a transport layer, or a network layer of a protocol stack.

According to one implementation, determining whether the cross-site script is an untrusted script, includes evaluating a likelihood of whether an input URL link includes a harmful code or non-benign instructions.

A second aspect provides a device is provided comprising a storage device storing software and a processing circuit coupled to the storage medium. The processing circuit may be configured: (a) intercept a Uniform Resource Locator (URL) link at a kernel level of an operating system of a device; (b) ascertain whether the URL link includes a cross-site script; (d) determine whether the cross-site script is an untrusted script; and/or (d) terminate execution of the URL link if it is determined that the cross-site script is an untrusted script.

In one example, determining whether the cross-site script is an untrusted script may include comparing a plurality of features of the URL link to a database of pre-identified features in malicious/untrusted URLs and/or benign/safe URLs.

In another example, determining whether the cross-site script is an untrusted script may include applying a reflected cross-site scripting (XSS) detection model to the URL link to determine the potential for a XSS attack within the URL link, wherein the XSS detection model is based on comparing a plurality of features of the URL link to a database of pre-identified features in malicious/untrusted URLs and/or benign/safe URLs.

In some instances, the untrusted script within the URL link is intended to perform unauthorized operations on an operating system or application executed on the device.

In other instances, determining whether the cross-site script is an untrusted script includes evaluating a likelihood of whether an input URL link includes a harmful code or non-benign instructions.

A third aspect provides a method, comprising: (a) intercepting a Uniform Resource Locator (URL) link at a kernel level of an operating system; (b) applying the URL link to a reflected cross-site scripting (XSS) detection model to determine the potential for a XSS attack within the URL link, wherein the XSS detection model is based on comparing a plurality of features of the URL link to a database of pre-identified features in malicious and/or benign URLs; and/or (c) terminating execution of the URL link if the reflected XSS detection model indicates a malicious script within the URL link.

In various examples, the URL link is intercepted: (a) at a TCP socket stream, (b) at a transport layer or a network layer of a protocol stack, or (c) by detecting an Android operating system Intent call.

The reflected XSS detection model may operate within a trusted zone of an operating system or processing circuit.

The malicious code within the URL link may be intended to perform unauthorized operations on the operating system or applications executed thereon.

In some instances, execution of the URL link is terminated by: (a) informing a user of the potential security risk posed by the URL link; and (b) terminating only upon receiving user instructions to do so.

In one example, execution of the URL link may be terminated by filtering out packets for the URL link from a TCP socket stream or a TCP network layer.

In another example, the plurality of features may be weighed according to the detection model to ascertain a likelihood that the URL link includes malicious XSS.

In some instances, the reflected XSS detection model may be a probabilistic model that evaluates a likelihood of whether an input URL link includes malicious script.

In yet other instance, the reflected XSS detection model may ascertain a probability that the URL link includes malicious code and execution of the URL link is terminated only if such probability exceeds a threshold probability.

A fourth aspect provides a device, comprising a storage medium storing software for web browsing and a processing circuit coupled to the storage medium. The processing circuit adapted to: (a) intercept a Uniform Resource Locator (URL) link at a kernel level of an operating system; (b) apply a reflected cross-site scripting (XSS) detection model to the URL link to determine the potential for a XSS attack within the URL link, wherein the XSS detection model is based on comparing a plurality of features of the URL link to a database of pre-identified features in malicious and/or benign URLs; and/or (c) terminate execution of the URL link if the reflected XSS detection model indicates a malicious script within the URL link.

In one example, the URL link is intercepted: (a) at a TCP socket stream; (b) at a transport layer or a network layer of a protocol stack; or (c) by detecting an Android operating system intent call.

### DRAWINGS

FIG. 1 illustrates an example of a reflected cross site scripting attack.

FIG. 2 is a block diagram illustrating a first approach for intercepting URLs at the kernel level of an operating system layer and detecting a cross site scripting attack.

FIG. 3 is a block diagram illustrating a second approach for intercepting URLs at a HLOS and operating system layer and detecting a cross site scripting attack.

FIG. 4 illustrates an exemplary method of building and using a cross site scripting detection model.

FIG. 5 is a table illustrating examples of features/attributes that may be identified within a URL link to build a classification model to assist in a detection of a cross site script.

FIG. 6 is a flow diagram illustrating an exemplary device that may be configured to perform for cross site scripting detection at a kernel-level and/or HLOS/operating system level.

FIG. 7 is a flow diagram illustrating an exemplary method for building a cross site scripting detection model offline and subsequently uploading to a device.

FIG. 8 is a flow diagram illustrating a first exemplary method for cross site scripting detection at a kernel-level and/or I-LOS/operating system level of a device.

FIG. 9 is a flow diagram illustrating a second exemplary method for cross site scripting detection at a kernel-level and/or HLOS/operating system level of a device.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

### Overview

An anti-XSS feature is provided at an operating system without reliance on higher-level third-party software (e.g., browsers, anti-virus software, etc.). In order to detect and/or prevent XSS attacks in a browser-independent way, URL information may be extracted at the operating system kernel's transport layer (herein also referred to as TCP layer), which is applied to any web traffic on a device, to detect an XSS attack.

This mechanism may intercept the URL from certain specific points in the High-Level Operating System (HLOS), kernel, and/or platform for any web access. In a first approach, URLs may be intercepted at a kernel's Transmission Control Protocol (TCP) socket stream and the data therein is decoded to ascertain whether an XSS attack is happening. In a second approach, data packets may be intercepted as they enter the TCP layer (or a network layer below the transport layer).

Additionally, a dynamic detection model may be used to detect an XSS attack by weighing a plurality of detected features in a URL and ascertaining if an untrusted XSS is present. As used herein, an “untrusted” script refers to a script that is potentially malicious, harmful, non-benign, and/or tainted, such as a script that includes code or instructions that perform operations to access, obtain, and/or extract data or information from a victim or victim's device, or victim's account without knowledge, notification to, or approval/authorization from the victim. In one example, an extended set of unique URL features may be examined to achieve higher detection accuracy for the dynamic XSS detection model. This extended set of unique URL features may be generated using machine learning approaches.

### Exemplary Reflected Cross-Site Scripting Detection and Prevention Approaches

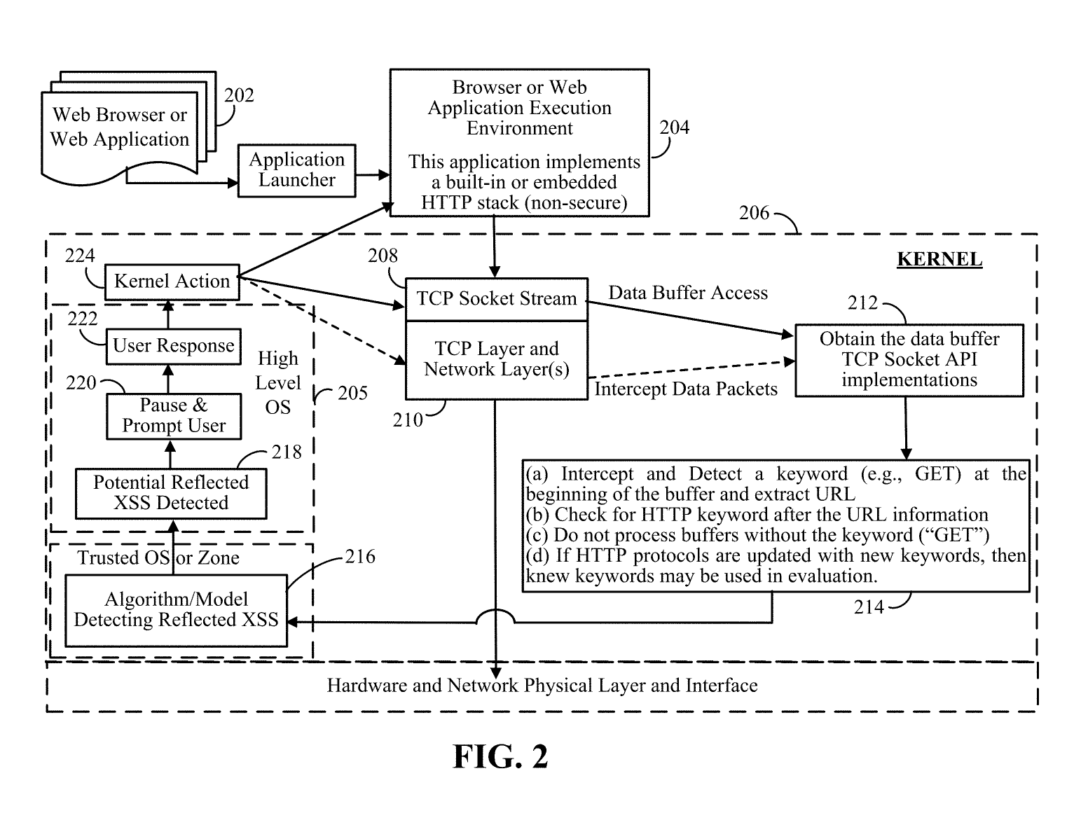

FIG. 2 is a block diagram illustrating a first approach for intercepting URLs and detecting XSS attack. Here, a web browser 202 may receive a URL using a built-in embedded HTTP stack 204 (i.e., not using the OS HTTP stack). In such approach, the URL is intercepted at the operating system's kernel 206 by accessing the TCP socket stream 208 and/or at the TCP layer and/or lower network layers 210. For instance, the URL may be obtained from a data buffer of the TCP socket stream or by intercepting data packets 212.

As used herein, a kernel is a computer program that constitutes the central core of a computing/processing device's operating system. The kernel may have complete control over everything that occurs in the device or system. As such, the kernel is typically the first program loaded on startup (e.g., bootup), and then manages the remainder of the startup, as well as input/output requests from software, translating them into data processing instructions for a device processing circuit. The kernel connects the application software to the hardware of a device. In one example, when an application or process uses system calls to make requests of the kernel.

In one example, the data buffer or data packets may be searched for a keyword (e.g., HTTP keyword GET), occurring after the URL information, to identify whether it should be processed to detect a potential XSS attack. That is, buffers without the keyword (e.g., GET) are not processed. If the keyword is detected, then the URL string may be processed by a detection model 216 (e.g., which may be implemented within a trusted OS) to ascertain whether it is a XSS attack. If a potential reflected-XSS attack is detected 218, then the OS may pause/block execution of the JavaScript (part of the URL string) and/or prompt the user of the security threat 220. The user may respond 222 with indication of some action to be taken (e.g., stop script or continue execution) and the kernel takes the action 224 (e.g., indicated by the user). To take such action, the kernel 206 may act upon the built-in embedded HTTP stack 204, the TCP socket stream 208, and/or the TCP layer and/or lower network layers 210 to block or remove execution of the URL code.

In one example, an Open System Interconnection (OSI) protocol network model (or equivalent) may be used to implement communications to/from a user device. Generally, the OSI reference model may be comprised of seven separate layers which include a physical layer (also referred to as Layer 1), a data link layer (also referred to as Layer 2), a network layer (also referred to as Layer 3), a transport layer (also referred to as Layer 4), a session layer (also referred to as Layer 5), a presentation layer (also referred to as Layer 6), and an application layer (also referred to as Layer 7). One example of a transport layer protocol is a Transmission Control Protocol (TCP) which is usually built on top of an Internet Protocol (IP). Consequently, the transport layer may be referred herein as the TCP layer. Note that in alternative implementations, different layers or a different number of layers may be used by a device.

The approach illustrated in FIG. 2 works for many implementation scenarios, including the case where the HTTP network stack is implemented within the browser/application 204. The kernel 206 may be modified to intercept the data buffer TCP socket stream 208. The TCP socket stream 208 puts the data for an HTTP packet into the buffer to be passed to the TCP layer. By obtaining the TCP Socket data buffer 212, operations may be performed to interception and/or detect keywords 214 indicative of an untrusted (e.g., potentially malicious, harmful, un-benign) script. The URL information may be extracted by decoding the first line of the URL by detecting one or more particular keywords (e.g., script instructions or commands) and/or script instruction sequence. For instance, if the script starts with a “GET” then the next part is the URL (with or without a hostname) followed by the HTTP protocol/version information. Any data not starting with the “GET” keyword can be bypassed or ignored, thereby reducing the processing time. Another aspect may limit the monitoring of URL information to just communications over port 80.

As an alternative, data packets can also be intercepted at the input of the TCP layer (transport layer) and decoded. Packet interception at network layers, below the TCP layer, is also possible by additional decoding based on the layer where it is intercepted.

In one example, upon detecting any a potential reflected-XSS exploit 218, the kernel 206 may instruct the HLOS 205 to pause and prompt the user 220 (e.g., pause the browser's renderer process/tab and open a dialog box for the user), warning about the potential danger and asking the user if he/she still wants to proceed. For instance, the kernel and/or HLOS may ask the user for permission to filter the untrusted script from the URL or block loading the URL. Upon a user response 222 (e.g., user wants to stop script), then the kernel may take action 224 to stop/filter the untrusted script from the URL.

The detection time taken by the XSS detection model to determine if the URL is safe or unsafe/untrusted is relatively fast. A mechanism to stop an XSS attack may filter out the HTTP packet carrying the untrusted URL (e.g., potentially malicious URL).

The kernel can send an alert to the user before the HTTP packet containing the untrusted URL is filtered out. The user has the option to respond whether to filter or not. The corresponding TCP packet (for the HTTP packet containing the untrusted URL) may be either dropped or sent to the web server based on the user's response 222.

In an alternative approach the kernel 206 may directly filter out the HTTP packet and display an interstitial webpage displaying a message of potential XSS attack from the URL and indicating that it has been prevented.

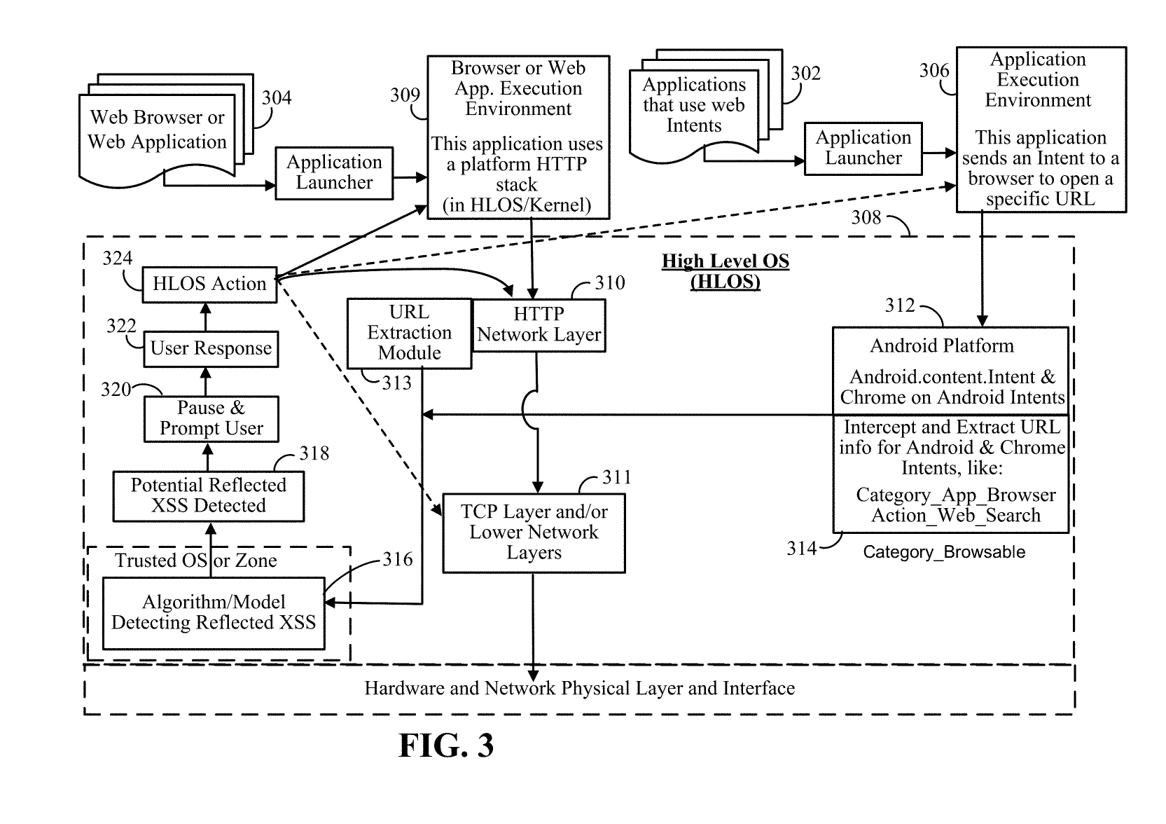

FIG. 3 is a block diagram illustrating a second approach for intercepting URLs at a high level operating system layer and detecting XSS attack. This example illustrates two additional approaches. In comparison to FIG. 2, this approach may be applicable to Android operating systems and the use of a web intent which let applications register themselves to get launched in response to certain specified actions. A URL opening is one of these actions. Web intents are a framework for web-based inter-application communication and service discovery.

In a first approach, a web browser or web application 304 may be executed in an execution environment 309 which uses a platform HTTP stack in the HLOS instead of built into the browser or web application. A URL extraction module 313 may forward HTTP packets obtained from the platform HTTP stack in the HLOS 308 to a detection model 316 which parses the HTTP packets to ascertain whether a untrusted script is embedded therein (e.g., identifies keywords). From there, if the detection model 316 identifies a potential XSS threat, it may inform the high level OS of the potential reflected XSS 318, which may pause execution of the URL and/or script and prompt the user 320 to provide a response 322. If the user indicates that the threatening script should be halted/filtered, the high level OS 308 is notified to take action 324 to filter/stop the XSS script at the HTTP network layer 310 the TCP layer (or lower network layers) 311, or at the browser or web application execution environment 309.

In a second approach, an application 302 that uses web intents may be executed in an execution environment 306. Here, an application 302 may send a web intent to a browser 304 (e.g., via an application execution environment 306) to open a specific URL. In such approach, the operating platform (e.g., Android OS) intercepts the intents 312 and detects extracts the URL information 314. Upon detection of the web intent and URL information, the URL string may be processed by a detection model 316 (e.g., which may be implemented within a trusted OS) to ascertain whether it is a XSS attack. If a potential reflected-XSS attack is detected 318, then the OS may pause/block execution of the script (e.g., Javascript with may be part of the URL string) and/or prompts the user of the security threat 320. The user may respond 322 with indication of some action to be taken (e.g., stop script or continue execution) and the HLOS takes the action 324 (e.g., indicated by the user). To take such action, the HLOS 308 may act upon the platform HTTP stack 309, the HTTP Network Layer 310, and/or the TCP layer and/or lower network layers 311 to block or remove execution of the URL code.

In one example, the high-level OS 308 may extract the URL information from browser intents, for applications that send browser intents for web access. Such extraction of URL information from browser intents may be done regardless of whether the application has a built-in HTTP stack or utilizes the platform's (e.g., HLOS/Kernel) HTTP stack.

In another example, the platform's HTTP stack (e.g., android's HTTP Network stack) can be instrumented to get URL information. This is not applicable for web browser/applications having a built-in or integrated HTTP stack.

### Exemplary Machine Learning Detection of Cross-Site Scripting Attacks

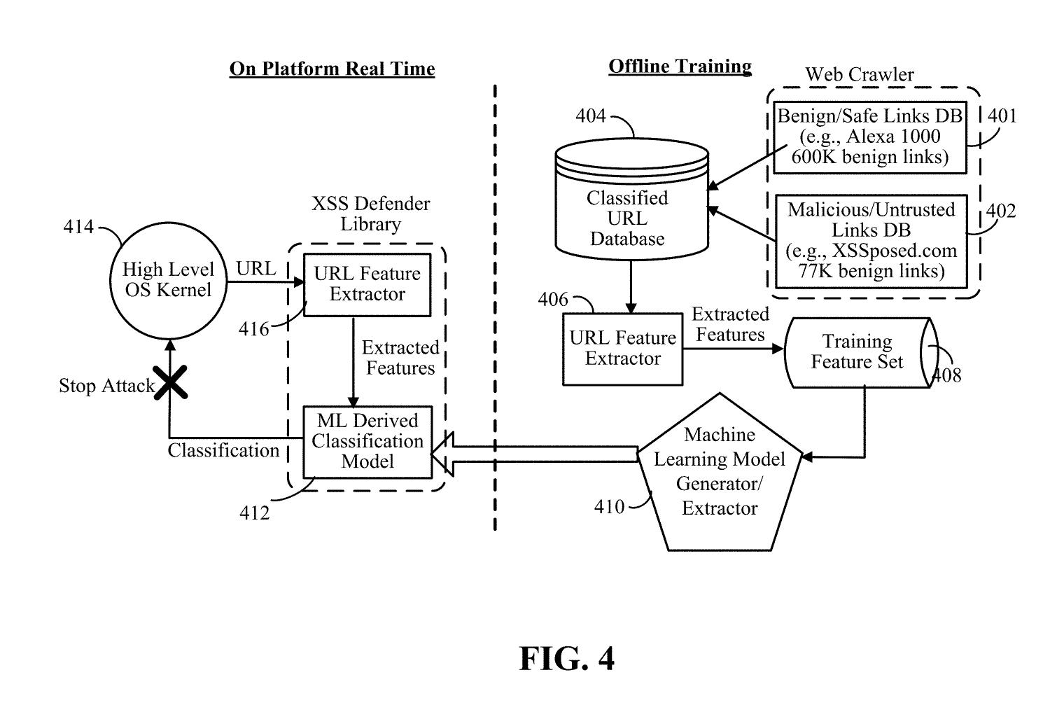

FIG. 4 illustrates an exemplary method of building and using an XSS detection model. In this example, one or more repositories of benign (safe) URL links 401 and/or malicious/untrusted URL links 402 (or a web crawler may simply search the web for URL links) may be used build a database 404. A feature extractor 406 may serve to parse and extract features from the URL links in the database 404. Such features may, for example, identify certain code sequences in a URL link that are common/frequent in benign/safe or malicious/untrusted links. With that information, a training feature set 408 may be built from which a machine learning model 410 may be generated. The machine learning model 410 may be built offline and subsequently uploaded to target devices. Note that the machine learning model 410 may be frequently updated and new versions of the model may be uploaded to target devices.

The machine learning model 410 may serve to implement a classification model 412 on a target device, which serves to identify whether a URL includes malicious/untrusted XSS. At the target device, when an URL is to be executed by the high level OS or kernel 414, a URL feature extractor 416 may extract a plurality of features which serve as input to the classification model 412. At the classification model 412, the extracted plurality of features may be weighed (according to the classification model) to ascertain the probability or likelihood that the URL link includes malicious/untrusted XSS. If so, the classification model 412 may stop the high-level operating system, kernel, and/or intents from executing the URL link (e.g., or code embedded therein).

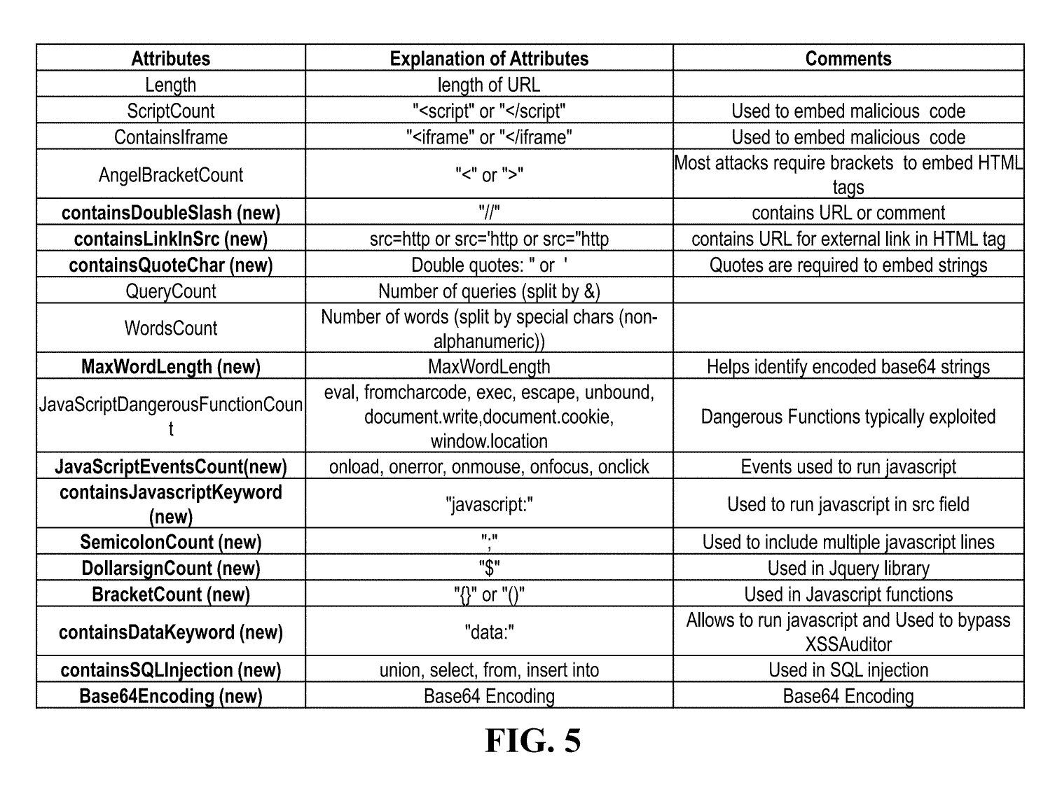

FIG. 5 is a table illustrating examples of features/attributes that may be identified within a URL link to build a classification model to assist in a probabilistic detection of malicious/untrusted XSS.

### Exemplary Device and Methods for Reflected Cross-Site Scripting Detection and Prevention

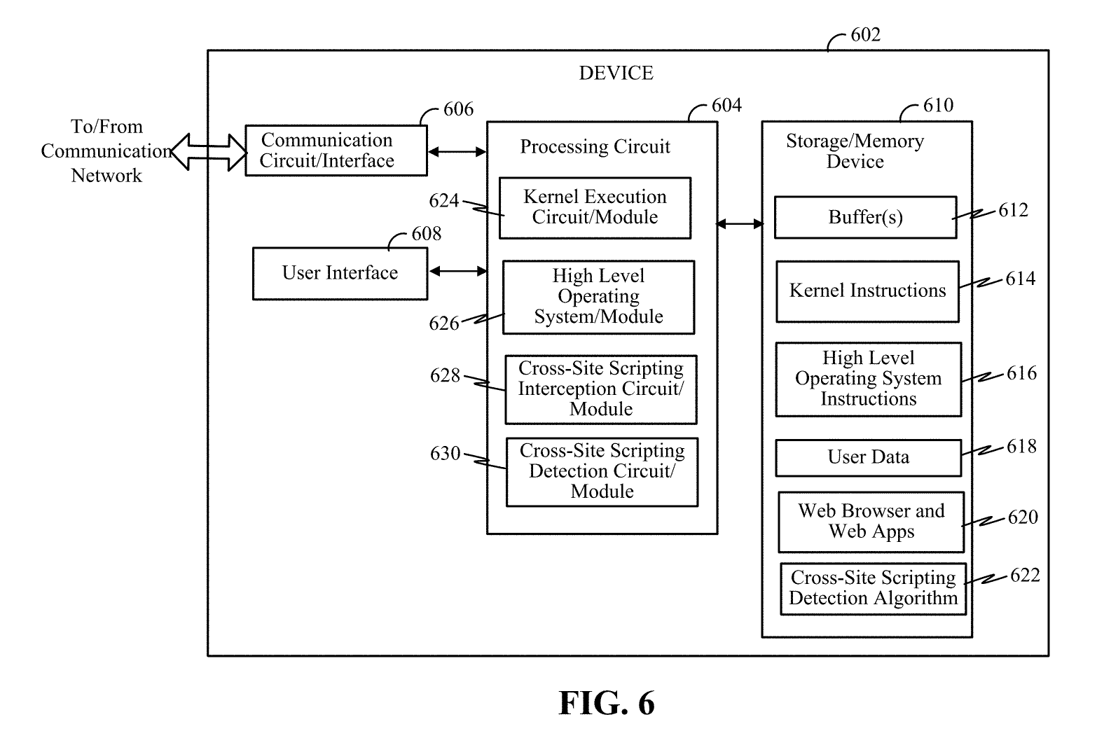

FIG. 6 is a flow diagram illustrating an exemplary device that may be configured to perform cross site scripting detection at a kernel-level and/or a high level operating system (HLOS) level. The device 602 may include a processing circuit 604, coupled to a communication circuit/interface 606, a user interface 608, and/or a storage/memory device 610. The communication circuit/interface 606 may serve to communicate over a communication network with other devices and/or servers (e.g., web servers, etc.). The user interface 608 may include an input interface/devices (e.g., keypad, touchpad, microphone, etc.) and output interface/devices (e.g., display screen, speaker(s), etc.).

The storage/memory device 610 may store or implement buffers 612, kernel instructions 614, high level operating system instructions 616, user data 618, web browser and/or web applications 620, and/or a cross-site scripting detection algorithm 622.

The processing circuit 604 may include a kernel execution circuit/module 624, a high level operating system/module 626, a cross-site scripting interception circuit/module 628, and/or a cross-site scripting detection circuit/module 630.

These instructions, circuits, and/or modules may be configured to implement one or more of the features in FIGS. 2, 3, 4, 5, 7, 8 and/or 9.

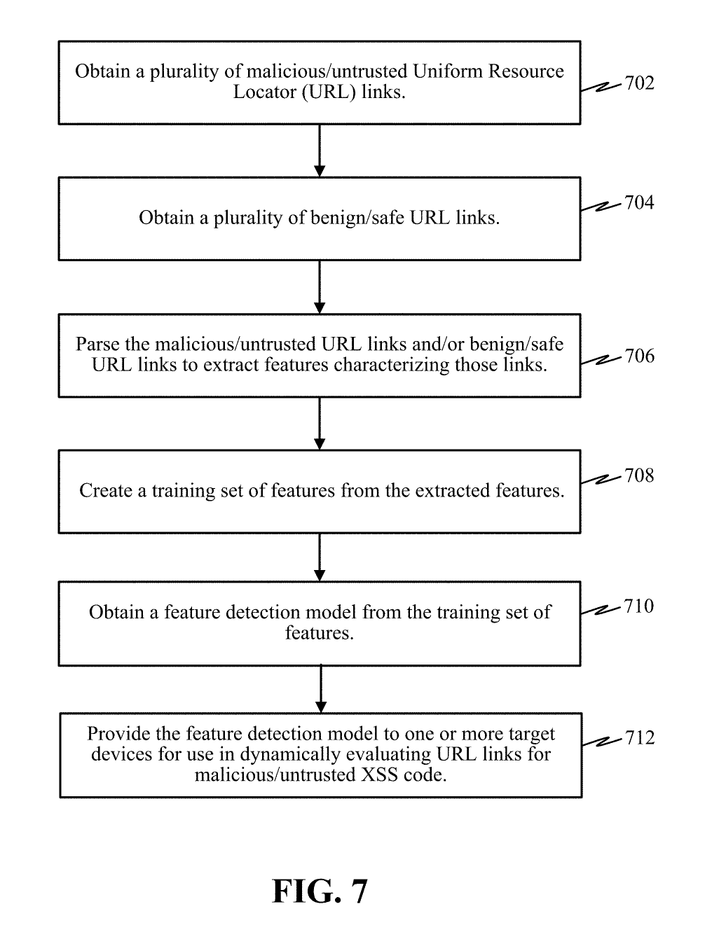

FIG. 7 is a flow diagram illustrating an exemplary method for building a cross site scripting detection model offline and subsequently uploading to a device. A plurality of malicious/untrusted Uniform Resource Locator (URL) links may be obtained 702. Similarly, a plurality of benign/safe URL links may be obtained 704. The malicious/untrusted URL links and/or benign/safe URL links may then be parsed to extract features characterizing those links 706. The extracted features may then be used to create a training set of features 708. For instance, the occurrence or non-occurrence of certain features in malicious/untrusted and/or benign/safe URL links may serve to build the training features set, in a probabilistic fashion and/or by weighing each feature, that serve to identify the likelihood of a malicious URL link. A feature detection model may then be obtained from the training set of features 710 which is provided to one or more target devices for use in dynamically evaluating URL links for malicious/untrusted XSS code 712.

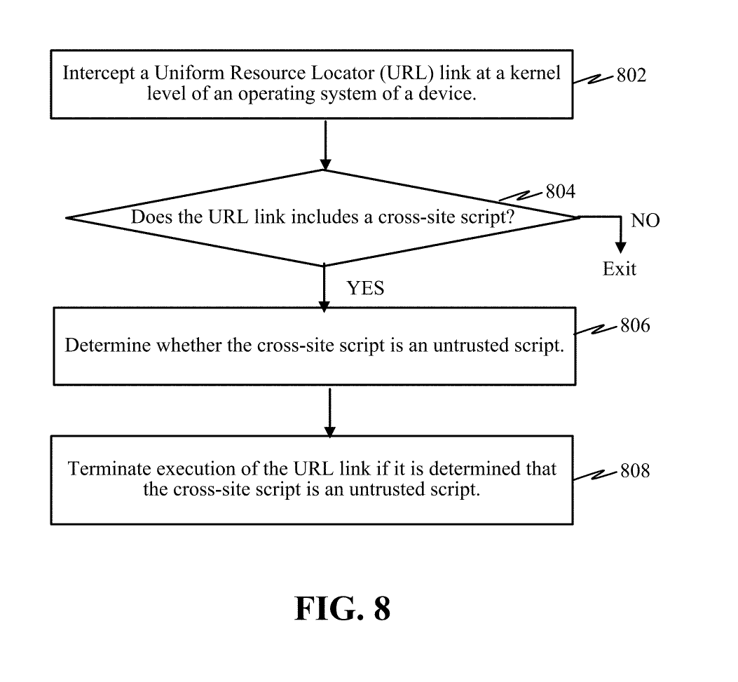

FIG. 8 is a flow diagram illustrating a first exemplary method for cross site scripting detection at a kernel-level and/or a HLOS level of a device. A Uniform Resource Locator (URL) link may be intercepted at a kernel level of an operating system of a device 802. It is then ascertained whether the URL link includes a cross-site script 804. If so, a determination is then made as to whether the cross-site script is an untrusted script 806. Execution of the URL link terminating if it is determined that the cross-site script is an untrusted script 808.

In on example, the determination of whether the cross-site script is an untrusted script may be done in a probabilistic manner. The probabilistic determination may include comparing a plurality of features of the URL link to a database of pre-identified features in malicious/untrusted and/or benign/safe URLs. If the cross-site script includes a URL listed in the malicious/untrusted URLs, then it may be considered untrusted. Additionally or alternatively, if the cross-site script includes a URL listed in the benign/safe URLs, then it may be considered trusted.

Other or additional aspects of the cross-site script may be taken into account when determining whether it is untrusted or malicious. For instance, the particular instructions or sequence of instructions found within the cross-site script may also be evaluated/considered in determining whether a particular script is untrusted. In some implementations where several factors are used in determining whether a script is untrusted, each factor may be weighted in making such determination. In other implementations, one or more factors may be determinative while other factors may be weighted in making such determination.

In various examples, the URL link may be intercepted at: a TCP socket stream, a transport layer, or a network layer of a protocol stack. The URL link may be intercepted by detecting an Android operating system intent call.

The malicious/untrusted script within the URL link may be intended to perform unauthorized operations on an operating system or application executed on the device. In one example, the determination of whether a script is malicious/untrusted may be a probabilistic determination, e.g., if one or more factors evaluated indicate the script is potentially harmful, risky, suspicious, or malicious above a threshold or probability level, then the script may be deemed untrusted.

In one example, execution of the URL link may be terminated by: informing a user of the potential security risk posed by the URL link; and terminating the untrusted script only upon receiving user instructions to do so.

Execution of the URL link may be terminated by filtering out packets for the URL link from a TCP socket stream, a transport layer, or a network layer of a protocol stack.

The manner in which it is determined whether the cross-site script may be untrusted includes evaluating a likelihood, potential, and/or probability that an input URL link includes code or instructions that perform operations to access, obtain, direct, redirect, and/or extract data or information from a victim or victim's device, or victim's account without knowledge, notification to, or approval/authorization from the victim.

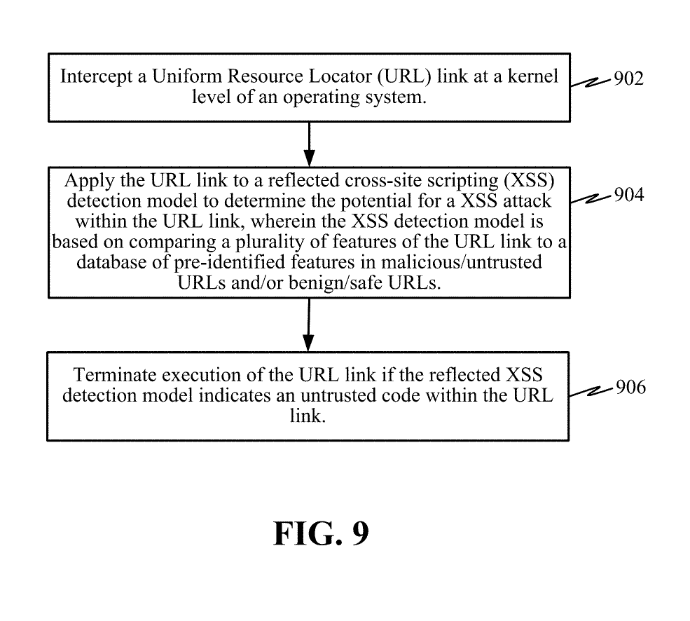

FIG. 9 is a flow diagram illustrating a second exemplary method for cross site scripting detection at a kernel-level and/or a HLOS level of a device. A Uniform Resource Locator (URL) link may be intercept at a kernel level of an operating system 902. A reflected cross-site scripting (XSS) detection model is then applied to the URL link to determine the potential for a XSS attack within the URL link, wherein the XSS detection model is based on comparing a plurality of features/content of the URL link to a database of pre-identified features of pre-identified malicious/untrusted URLs and/or benign/safe URLs 904. Execution of the URL link is terminated if the reflected XSS detection model indicates an untrusted code within the URL link 906.

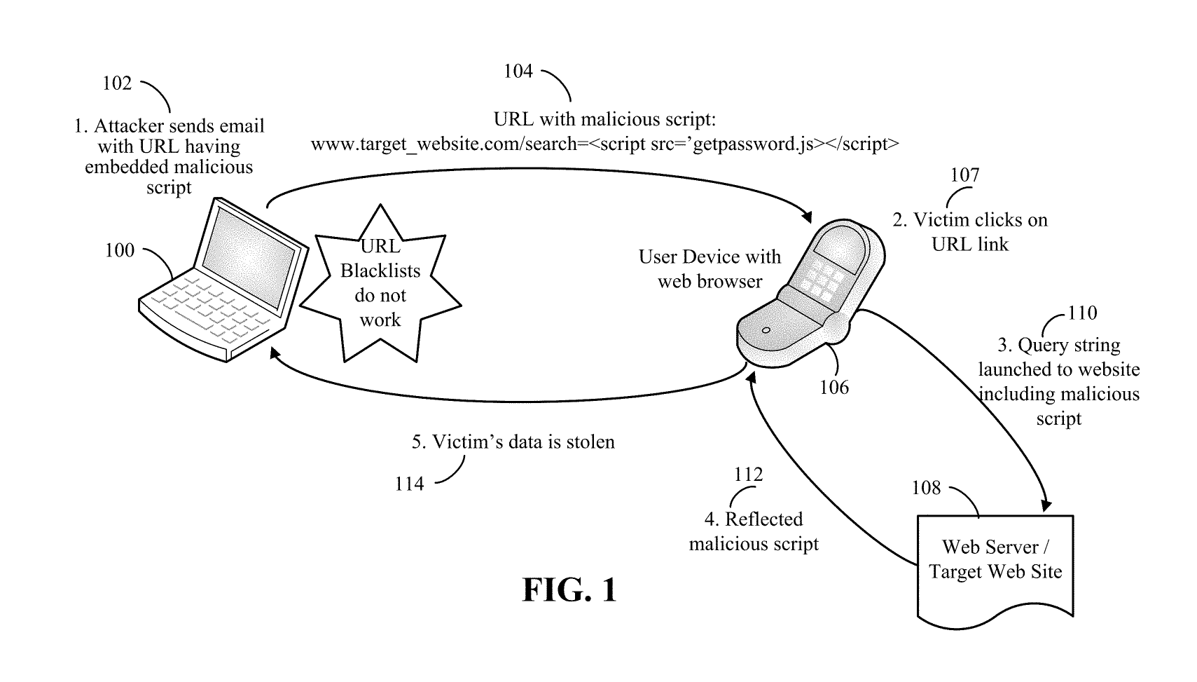

While the above discussed aspects, arrangements, and embodiments are discussed with specific details and particularity, one or more of the components, steps, features and/or functions illustrated in FIGS. 1, 2, 3, 4, 5, 6, 7, 8 and/or 9 may be rearranged and/or combined into a single component, step, feature or function or embodied in several components, steps, or functions. Additional elements, components, steps, and/or functions may also be added or not utilized without departing from the present disclosure. The novel algorithms described herein may also be efficiently implemented in software and/or embedded in hardware.

While features of the present disclosure may have been discussed relative to certain embodiments and figures, all embodiments of the present disclosure can include one or more of the advantageous features discussed herein. In other words, while one or more embodiments may have been discussed as having certain advantageous features, one or more of such features may also be used in accordance with any of the various embodiments discussed herein. In similar fashion, while exemplary embodiments may have been discussed herein as device, system, or method embodiments, it should be understood that such exemplary embodiments can be implemented in various devices, systems, and methods.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method, comprising:
intercepting a Uniform Resource Locator (URL) link at a kernel level of an operating system of a device;
ascertaining whether the URL link includes a cross-site script;
determining whether the cross-site script is an untrusted script; and
terminating execution of the URL link if it is determined that the cross-site script is an untrusted script.

2. The method of claim 1, wherein determining whether the cross-site script is an untrusted script, includes
comparing a plurality of features of the URL link to a database of pre-identified features in malicious/untrusted URLs and/or benign/safe URLs.

3. The method of claim 1, wherein the URL link is intercepted at a TCP socket stream.

4. The method of claim 1, wherein the URL link is intercepted at a transport layer or a network layer of a protocol stack.

5. The method of claim 1, wherein the URL link is intercepted by detecting an Android operating system intent call.

6. The method of claim 1, wherein the untrusted script is a reflected cross site script.

7. The method of claim 1, wherein the untrusted script within the URL link is intended to perform unauthorized operations on an operating system or application executed on the device.

8. The method of claim 1, wherein execution of the URL link is terminated by:
informing a user of a potential security risk posed by the URL link; and
terminating the untrusted script only upon receiving user instructions to do so.

9. The method of claim 1, wherein execution of the URL link is terminated by filtering out packets for the URL link from a TCP socket stream, a transport layer, or a network layer of a protocol stack.

10. The method of claim 1, wherein determining whether the cross-site script is an untrusted script, includes evaluating a likelihood of whether an input URL link includes a harmful code or non-benign instructions.

11. A device, comprising:
a storage device storing software;
a processing circuit coupled to the storage device, the processing circuit configured to:
intercept a Uniform Resource Locator (URL) link at a kernel level of an operating system;
ascertain whether the URL link includes a cross-site script;
determine whether the cross-site script is an untrusted script; and
terminate execution of the URL link if it is determined that the cross-site script is an untrusted script.

12. The device of claim 11, wherein determining whether the cross-site script is an untrusted script includes
comparing a plurality of features of the URL link to a database of pre-identified features in malicious/untrusted URLs and/or benign/safe URLs.

13. The device of claim 11, wherein determining whether the cross-site script is an untrusted script, includes
applying a reflected cross-site scripting (XSS) detection model to the URL link to determine a potential for a XSS attack within the URL link, wherein the XSS detection model is based on comparing a plurality of features of the URL link to a database of pre-identified features in malicious/untrusted URLs and/or benign/safe URLs.

14. The device of claim 11, wherein the untrusted script is a reflected cross site script.

15. The device of claim 11, wherein the untrusted script within the URL link is intended to perform unauthorized operations on an operating system or application executed on the device.

16. The device of claim 11, wherein determining whether the cross-site script is an untrusted script includes evaluating a likelihood of whether an input URL link includes a harmful code or non-benign instructions.

17. A device, comprising:
a storage medium storing software for web browsing;
a processing circuit coupled to the storage medium, the processing circuit configured to:
intercept a Uniform Resource Locator (URL) link at a kernel level of an operating system;
apply a reflected cross-site scripting (XSS) detection model to the URL link to determine a potential for a XSS attack within the URL link, wherein the XSS detection model is based on comparing a plurality of features of the URL link to a database of pre-identified features in malicious and/or benign URLs; and
terminate execution of the URL link if the reflected XSS detection model indicates a malicious script within the URL link.

18. The device of claim 17, wherein the URL link is intercepted:
(a) at a TCP socket stream;
(b) at a transport layer or a network layer of a protocol stack; or
(c) by detecting an Android operating system intent call.

19. The device of claim 17, wherein the URL link is intercepted at a transport layer or a network layer of a protocol stack.

20. The device of claim 17, wherein the XSS attack within the URL link is intended to perform unauthorized operations on an operating system or application executed on the device.
